(19) United States
(12) Patent Application Publication
(10) Pub. No.: US 2024/0301643 A1
(43) Pub. Date: Sep. 12, 2024

(54) DE-ICING SPRAYER

(71) Applicants: Tom J. Mäenpää, Pietarsaari (FI); Frank E. Mäenpää, Pietarsaari (FI); Krister Sundqvist, Bennäs (FI); Martin Ventin, Lepplax (FI)

(72) Inventors: Tom J. Mäenpää, Pietarsaari (FI); Frank E. Mäenpää, Pietarsaari (FI); Krister Sundqvist, Bennäs (FI); Martin Ventin, Lepplax (FI)

(21) Appl. No.: 18/597,712

(22) Filed: Mar. 6, 2024

Related U.S. Application Data
(60) Provisional application No. 63/450,381, filed on Mar. 6, 2023.

(51) Int. Cl. E01H 10/00; B05B 12/12; B05B 13/00; E01C 23/01

(52) U.S. Cl. CPC E01H 10/007; B05B 12/12; B05B 12/126; B05B 13/005; E01C 23/01

(57) ABSTRACT

A liquid sprayer system is capable of efficiently spraying liquids, such as de-icing brine solution by precisely controlling the flow rate of an electrically-driven pump without need for returning excess flow to a storage tank. The liquid sprayer includes the storage tank, the pump, a variable-speed electric motor, a controller, and spray nozzles. The pump receives a liquid from the storage tank and directs it to the spray nozzles, from which the liquid is emitted toward a ground surface. The controller adjusts the speed of the electric motor, thereby adjusting the liquid flow rate, in response to at least one control input. The control input(s) may include a user-selected flow rate, a ground speed of the liquid sprayer, a remotely-selected flow rate based on current or predicted weather conditions, detected road temperature or contamination, a planned route of the vehicle, and a size or operating configuration of the spray nozzles.

### CROSS REFERENCE TO RELATED APPLICATION

The present application claims the benefit of U.S. provisional application Ser. No. 63/450,381, filed Mar. 6, 2023, which is hereby incorporated herein by reference in its entirety.

### FIELD OF THE INVENTION

The present invention generally relates to powered equipment for spraying liquids such as ice melters, fertilizers, water, and the like onto ground surfaces.

### BACKGROUND OF THE INVENTION

The distribution of liquid ice melters, such as brine solutions, is often performed to improve drivability of roadways before, during, and after incidents of frozen precipitation such as snowfall, hail, sleet, or freezing rain. The operation of typical spray systems requires a significant amount of electrical or mechanical energy to drive one or more pumps, and some of that power may be lost due to pumping excess liquid and returning unused liquid to a storage tank through an overflow or over-pressure valve and its associated plumbing.

### SUMMARY OF THE INVENTION

The present invention provides an electrically driven sprayer for liquids such as ice-melting brine solutions. The liquid sprayer includes a pump driving by a precisely-controlled electric motor that allows for precise flow rates, including lower flow rates that require less electrical power because the flow rate through the pump is reduced, rather than operating the pump at a higher-than-needed flow rate and returning a portion of the pumped liquid to a storage tank using energy that is essentially wasted on circulating some of the liquid out of the tank and returning it into the tank. This makes it feasible to power the pump using a self-contained power source such as a rechargeable battery pack that does not necessarily rely on electrical power or mechanical power from a transport vehicle that carries the sprayer. Thus, substantially any transport vehicle capable of safely supporting the mass of the liquid sprayer may be used to transport the sprayer, even if the vehicle is not equipped with a power take-off (“PTO”), a high-capacity electrical outlet, a hydraulic pump, or a high-capacity electrical generating system.

In one form of the present invention, a liquid sprayer is provided for distributing de-icing brine solution or other liquids to a roadway or other surface, at variable flow rates and in a power-efficient manner. The sprayer includes a storage tank, a pump, a variable-speed electric motor, a controller, a self-contained electrical power source, and a plurality of spray nozzles. The pump receives a liquid from the storage tank and directs it to the spray nozzles, and from there the liquid is sprayed or otherwise distributed toward a ground surface. The self-contained electrical power source is provided for powering the electric motor and the controller. Optionally, the pump is a positive-displacement pump so that the flow rate through the pump, and consequently to the spray nozzles and ultimately the ground surface, can be precisely controlled.

According to one aspect, the controller adjusts the speed of the electric motor, thus adjusting the liquid flow rate, in response to at least one control input such as a user-selected flow rate; a ground speed of the liquid sprayer; a measured ground contamination level and type; a measured ground temperature; ambient air temperature; ambient air humidity; a remotely-selected flow rate based on past, current, or forecasted weather conditions; a planned route of the liquid sprayer; and a size or configuration of the spray nozzles.

According to another aspect, the spray nozzles are mounted upon a spray bar forming a conduit between the liquid pump and the spray nozzles.

According to yet another aspect, the spray nozzles are aimable and/or have adjustable spray patterns. Optionally, the spray nozzles are remotely controllable for aim and/or spray pattern.

According to still another aspect, the self-contained electrical power source is in the form of a rechargeable electrical storage battery. Optionally, the rechargeable electrical storage battery includes one or two batteries each having a rated voltage output of 12V DC, such that the output voltage of the overall rechargeable electrical storage battery is 12V or 24V DC.

According to a further aspect, the liquid sprayer is mountable on a transport vehicle for dispensing the liquid onto a roadway.

According to a still further aspect, the electrical power source does not receive electrical charging current from a wiring harness of the transport vehicle, and is thus independent of any electrical charging system associated with the transport vehicle.

According to another aspect, the speed of the variable-speed electric motor is continuously variable between a minimum speed and a maximum speed, and the resultant liquid flow rates are variable in direct proportion the speed of the variable-speed electric motor. Optionally, the liquid pump is a positive-displacement pump such as a self-priming diaphragm pump.

According to yet another aspect, the controller and the electric motor are operable to change the liquid flow rate of the pump at intervals of 0.1 second or less based on the at least one control input.

According to a further aspect, the liquid pump is operable to pump the liquid into the liquid storage tank from a remote liquid source.

According to still another aspect, the electric motor and the liquid pump are operable to pump a brine solution through the spray nozzles at 110 liters per minute, collectively.

According to a yet further aspect, the controller is configured to automatically adjust the speed of the electric motor in response to a current flow rate, a current fluid pressure upstream of the spray nozzles, a desired liquid application rate, and a speed of the spray nozzles over a ground surface.

According to another aspect, the liquid pump does not have a return line for directing excess flow back to the liquid storage tank.

Therefore, the liquid sprayer of the present invention can be transported, operated, and transferred from one vehicle to another as an independent and self-contained system that relies on its own onboard power supply(ies) and efficient pumping operation that minimizes energy waste through over-application and circulating liquid back into the storage tanks. As a result, substantially any transport vehicle, ranging from small groundskeeping vehicles the size of golf carts, to consumer-size trucks, to large commercial-size utility trucks, can be used to transport the sprayer provided that the sprayer's size and weight are compatible with the vehicle. This can be done even if the vehicle is not equipped with a power take-off (“PTO”), a high-capacity electrical outlet, a hydraulic pump, or a high-capacity electrical generating system.

These and other objects, advantages, purposes and features of the present invention will become apparent upon review of the following specification in conjunction with the drawings.

### BRIEF DESCRIPTION OF THE DRAWINGS

FIG. 1 is a left-rear perspective view of a liquid de-icing sprayer in accordance with the present invention;

FIG. 2 is an exploded left-rear perspective view of the liquid de-icing sprayer;

FIG. 3 is a left side elevation view of the liquid de-icing sprayer;

FIG. 4 is a right side elevation view of the liquid de-icing sprayer;

FIG. 5 is a top plan view of the liquid de-icing sprayer;

FIG. 6 is a bottom plan view of the liquid de-icing sprayer;

FIG. 7 is a front elevation view of the liquid de-icing sprayer;

FIG. 8 is a left-rear perspective view of a rear housing of the liquid de-icing sprayer, shown with doors open to reveal interior components;

FIG. 9 is a rear elevation view of the rear housing of FIG. 8;

FIG. 10 is a perspective view of an electric motor, gearbox, and liquid pump of the liquid de-icing sprayer;

FIG. 11 is a perspective view of a left side spray bar end portion of the liquid de-icing sprayer;

FIG. 12 is an exploded perspective view of the spray bar end portion of FIG. 11;

FIG. 13 is a partially-exploded perspective view of a right side spray bar end portion of the liquid de-icing sprayer;

FIG. 14 is a schematic liquid flow diagram of the liquid de-icing sprayer;

FIG. 15 is a diagram of a vehicle supporting another liquid de-icing sprayer in accordance with the present invention;

FIG. 16 is a rear elevation view of a rear housing of the liquid de-icing sprayer of FIG. 15, shown with doors open to reveal interior components;

FIG. 17 is a perspective view of a filling valve assembly of the liquid de-icing sprayer of FIG. 15;

FIG. 18 is a perspective view of a valve assembly with multiple liquid valves and respective flow meters of the liquid de-icing sprayer of FIG. 15;

FIG. 19 is a schematic liquid flow diagram of the liquid de-icing sprayer of FIG. 15, including an inset electrical charging arrangement; and

FIG. 20 is a schematic electrical diagram of the liquid de-icing sprayer of FIG. 15.

### DETAILED DESCRIPTION OF PREFERRED EMBODIMENTS

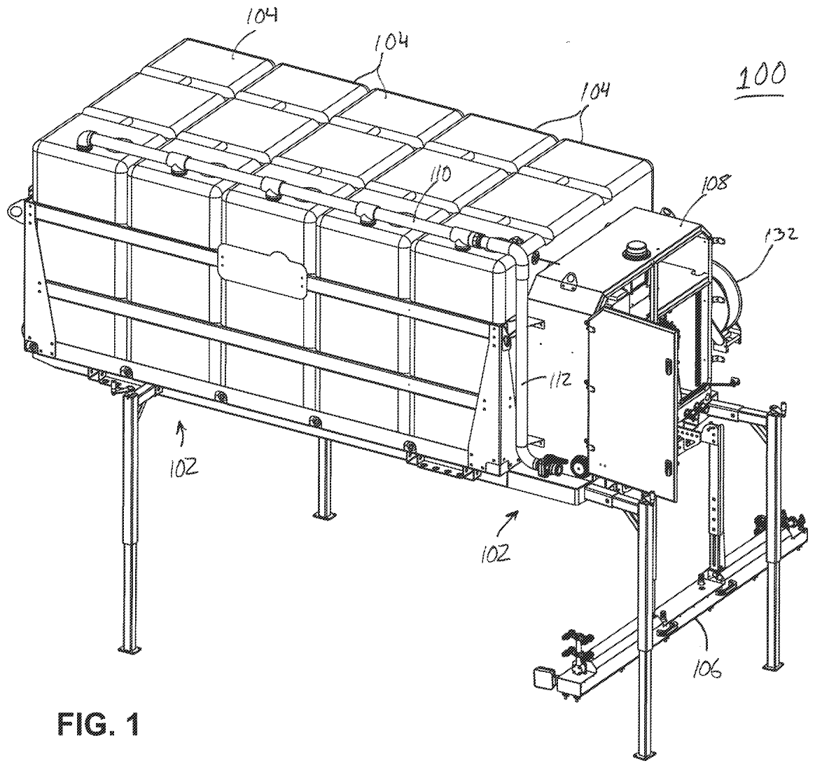

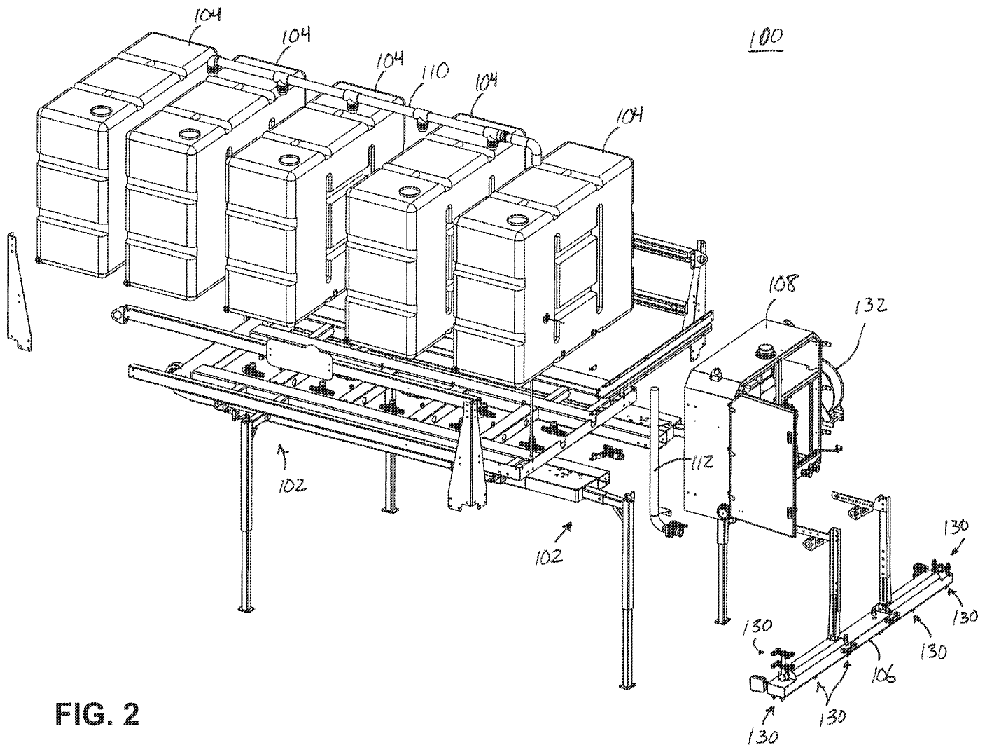

Referring now to the drawings and the illustrative embodiments depicted therein, a liquid sprayer 100 includes a support frame 102, a plurality of liquid storage tanks 104, a spray bar 106, and a housing 108 containing power, pump, control, and plumbing components (FIGS. 1 and 2). As will be described in more detail below, liquid sprayer 100 can be supported on various types of vehicles, typically road vehicles such as pickup trucks and large utility trucks, but may also be supported on grounds keeping vehicles such as tractors or even powered utility carts, and scaled up or down according to the application and vehicle. The liquid sprayer 100 is designed to be energy efficient and self-powered, such as with onboard rechargeable batteries, so that it does not necessarily rely upon the vehicle as a power source. This allows the sprayer 100 to be mounted on a wide variety of vehicles, including those lacking power take-offs (“PTO's”) and/or high-capacity electrical power outlets, and recharged or refreshed with charged batteries when charging equipment or freshly charged batteries are again available, such as in a storage, maintenance, or dispatch facility.

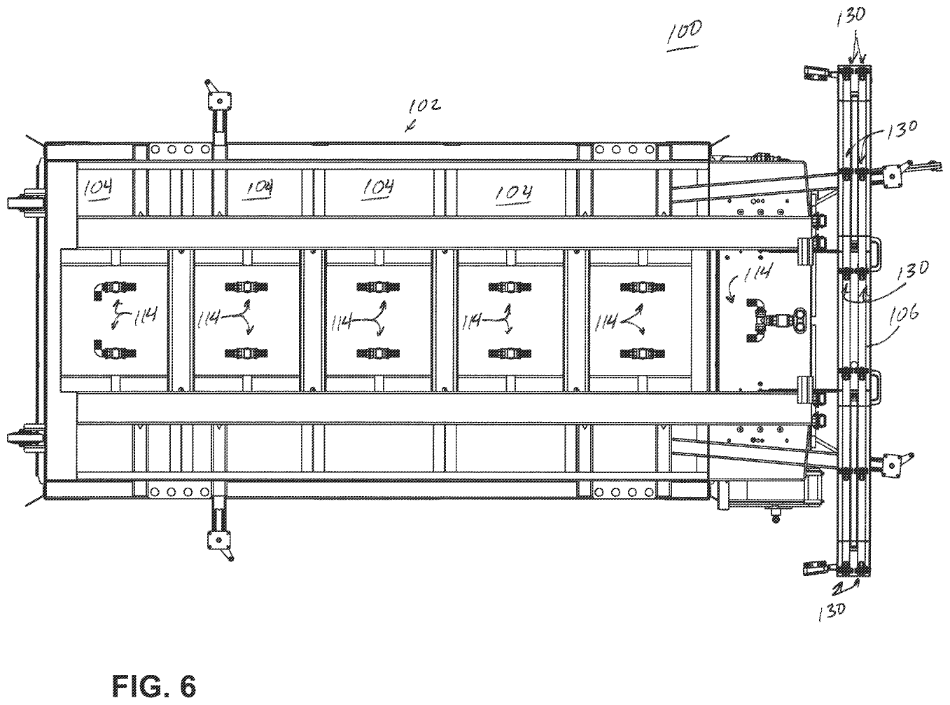

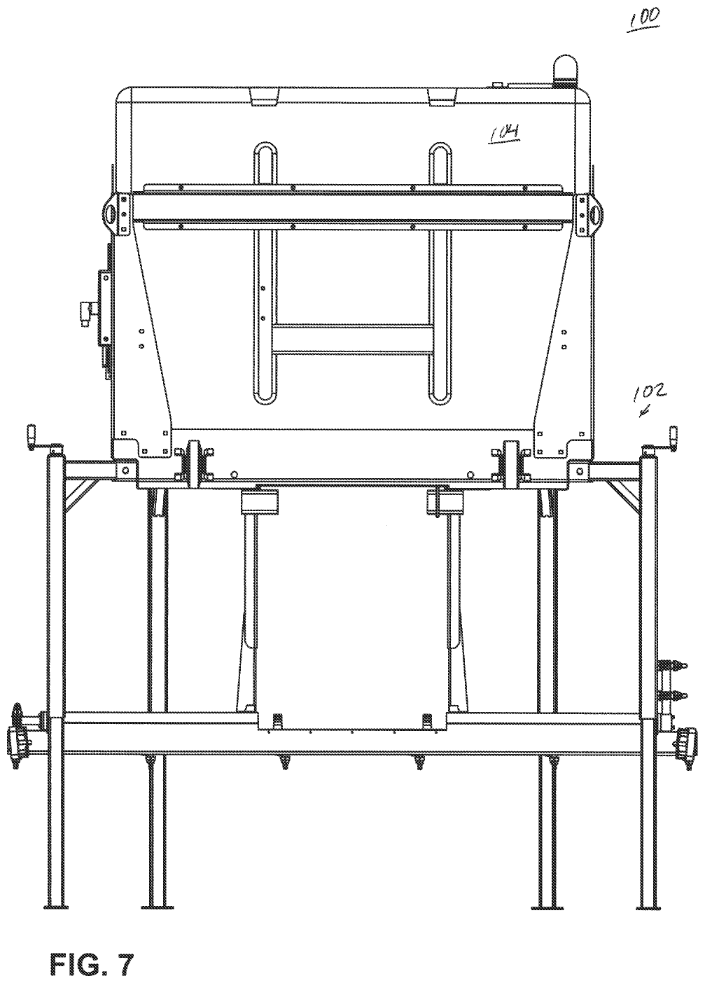

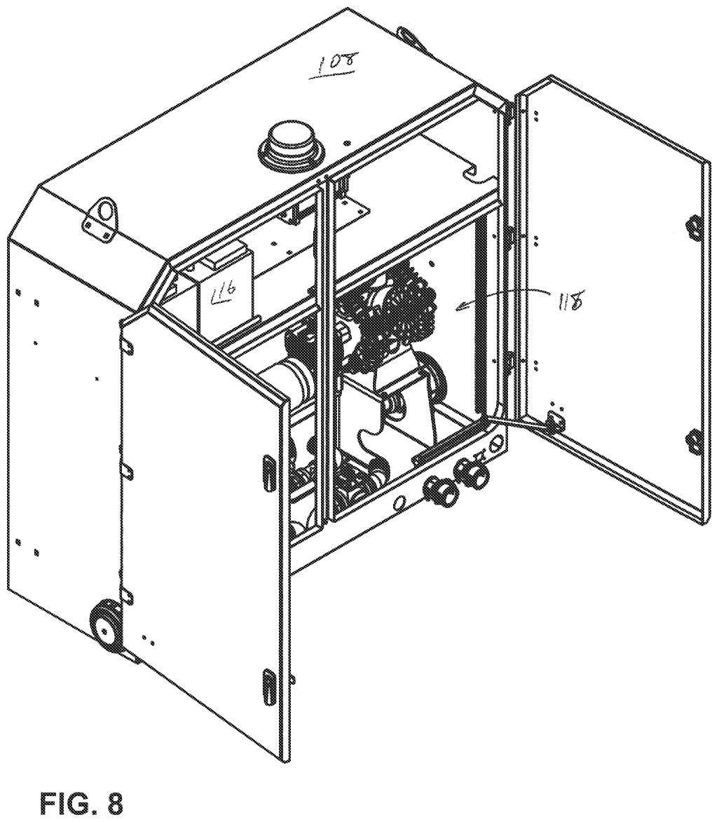

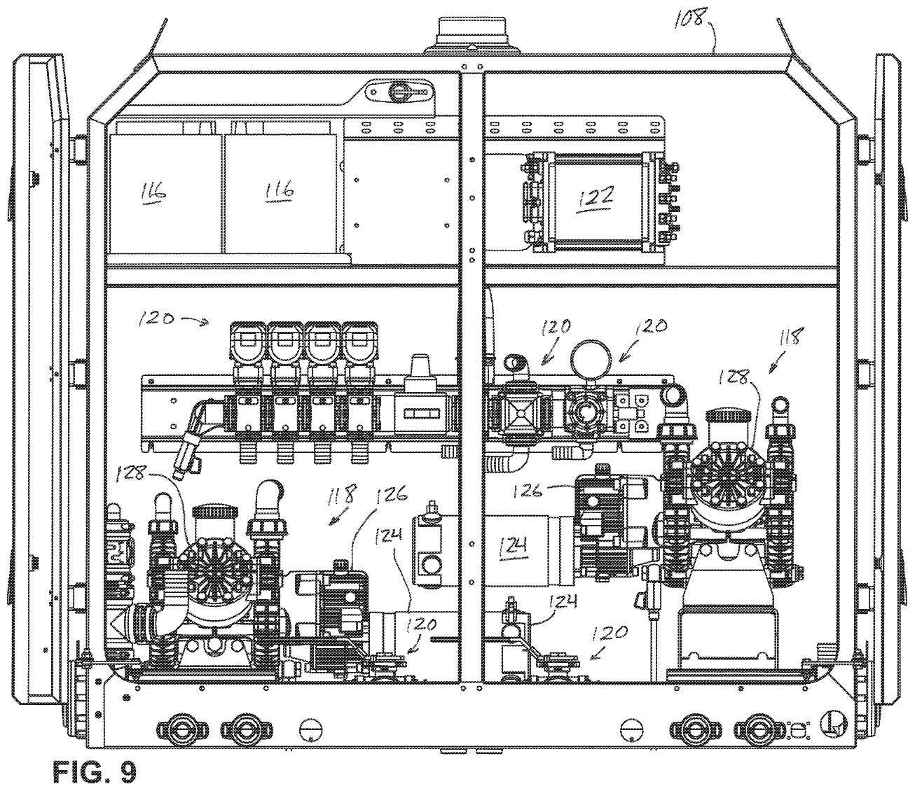

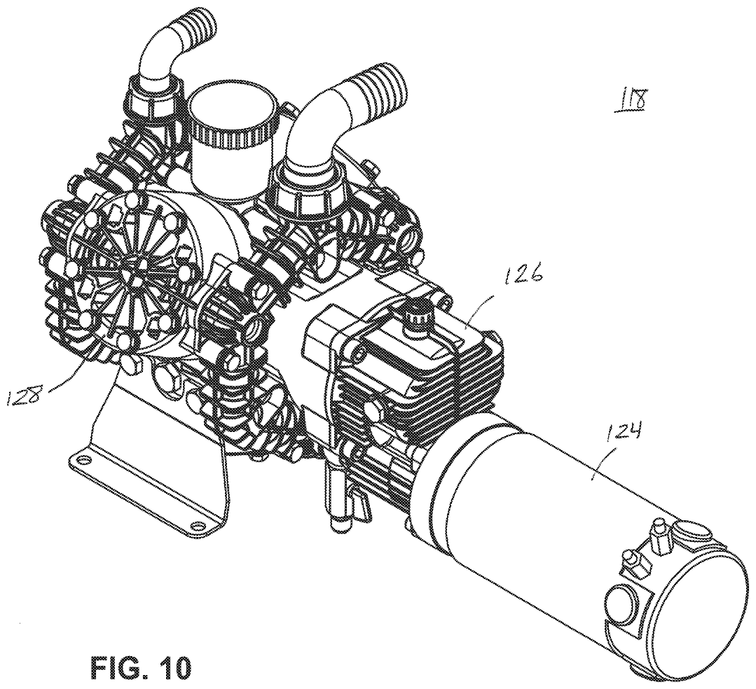

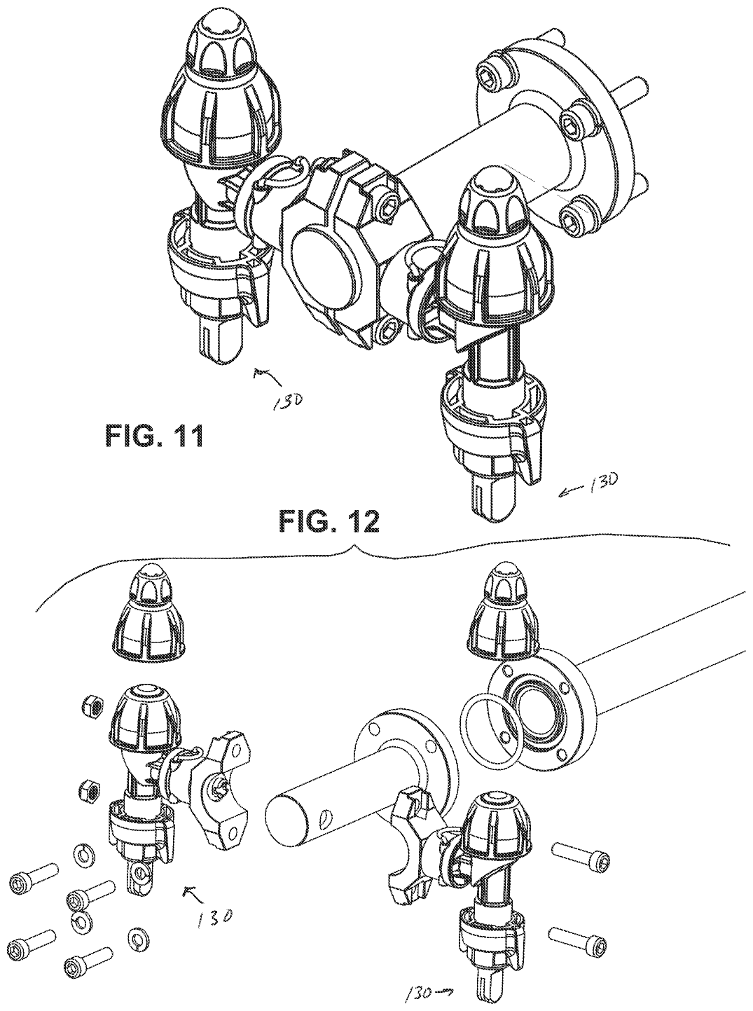

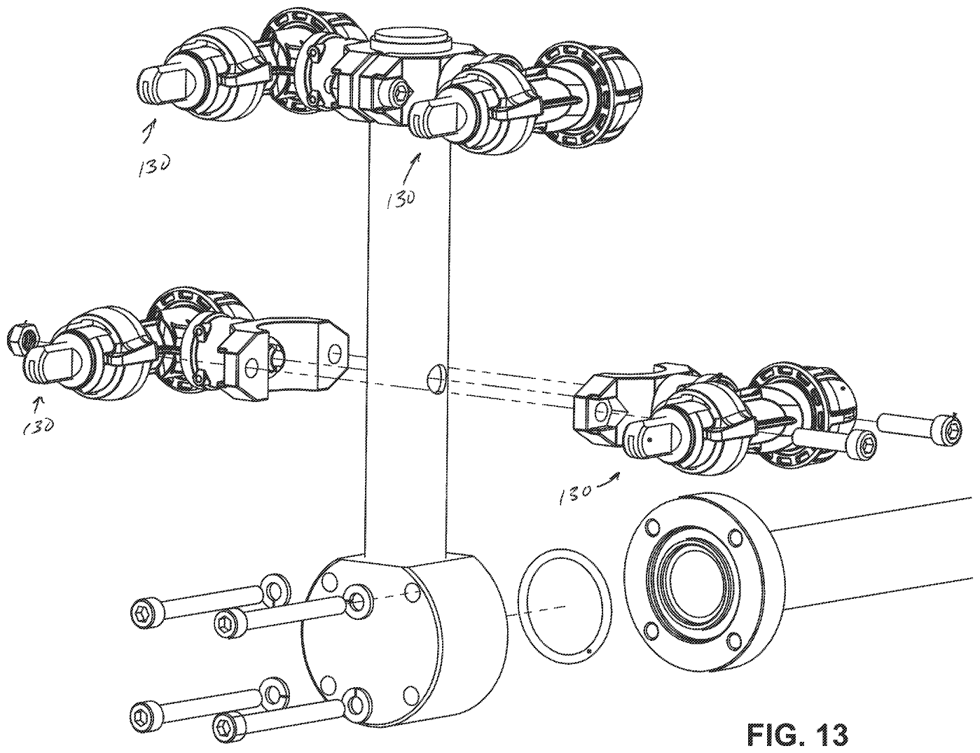

Storage tanks 104 are in fluid communication with one another via a pipe manifold 110 that couples to a fluid line 112. A system of lower plumbing fittings 114 (FIGS. 2 and 6) provides additional fluid couplings to the storage tanks 104 via lower pipes (not shown) for supplying the liquid to components in the housing 108, and optionally for directing refilling liquid into the storage tanks 104 as will be described below. Referring to FIG. 9, a self-contained electrical power source in the form of two rechargeable 12V DC batteries 116 are mounted at an upper region of housing 108 and may be wired in parallel for an output of about 12V DC, or may be wired in series for an output of about 24V DC. Optionally, when batteries 116 are arranged in parallel for a total of 12V DC output, they may receive charging power from the vehicle's charging system such as its engine-driven electrical alternator. They may also be recharged by a mains-powered DC or AC power source, such as at a maintenance facility. When batteries 116 are arranged in series for a total of 24V DC, they are more likely to require charging by a mains-powered DC or AC power source, such as at a maintenance facility, since many vehicle charging systems are limited to DC outputs of 14V to 16V DC. It will be appreciated that the sprayer systems disclosed herein may operate at higher or lower voltages than the 12V and 24V DC that are primarily described herein, such as to facilitate use of pump motors and motorized valve actuators that operate at different voltages to achieve different performance figures that may be desired for certain applications. It is also envisioned that voltage converters may be used so that equipment designed for operation at different voltages (or both DC and AC power in the same system) may be accommodated in the same sprayer system.

Housing 108 contains two pump units 118, numerous valves 120 and conduits (of which hoses are omitted from FIG. 9 to provide better views of other structures), and a controller 122. The controller 122 is operable to precisely control the speeds of variable-speed electric motors 124 of respective pump units 118, the pump units 118 having gearboxes 126 disposed between the motors 124 and positive-displacement liquid pumps 128. Pump units 118 are thus operable at precisely variable and controllable flow rates in response to one or more control inputs received by controller 122. Spray bar 106 receives the precisely-metered and pressurized liquid from one or both pumps 128, and includes a plurality of spray nozzles 130 defining outlet openings, which are optionally aimable and may have controllable spray patterns or flow volumes, such as may be controlled via a “StrikeSmart” brand in-cabin controller, available from Oy Hilltip Ab of Pietarsaari, Finland.

Control inputs to controller 122, which are used to determine the desired flow rate from pumps 128 to spray bar 106, may include a user-selected flow rate, a ground speed of the liquid sprayer, road surface (or other application surface) temperature, ambient air temperature, ambient air humidity, salinity level on the road surface (or other application surface), a remotely-selected flow rate based on past, current, or forecasted weather conditions, a planned route of the liquid sprayer, and a size or configuration of the spray bar 106. For example, the number and types and configurations of nozzles 130 at spray bar 106 will affect the maximum flow rate and distribution width. As a transport vehicle moves from one geographical area to another, the amount of past precipitation, the current precipitation rate, current air temperature and humidity, temperature and existing salinity level of the road surface under the vehicle, and the forecasted future precipitation in the areas being traversed by the vehicle at the present time and predicted to be traversed in the future, may be used to calculate an optimum flow rate that changes as the vehicle moves from an area of lesser precipitation to an area of higher predicted precipitation. The flow rate will also be increased at higher vehicle speeds and decreased at lower speeds to ensure a more even distribution of liquid along ground surfaces (such as roadways) traversed by the vehicle at different speeds. The computations for desired flow rates and communications to controller 122 may be performed, for example, by the “HTrack” tracking system available from Oy Hilltip Ab of Pietarsaari, Finland. The HTrack system is capable of collecting and analyzing multiple data sources from a remote location and communicating desired liquid application or flow rate(s) to controller 122 based on the observed GPS-derived location of controller 122, as well as other environmental factors, the type of liquid carried in tanks 104, and the like.

Because pump units 118 may be powered entirely by on-board batteries 116, it is envisioned that no electrical charging current will be required from the transport vehicle used to carry the liquid sprayer 100. Thus, it is unnecessary for the vehicle to be equipped with a power take-off (“PTO”), a high-capacity electrical outlet, a hydraulic pump, or a high-capacity electrical generating system. Moreover, the controller 122 and the electric motors 124 are operable to change the liquid flow rate of the pumps 128 at intervals of 0.1 second or less based on the control input(s), so that liquid flow rate through spray bar 106 is automatically adjusted to account for current, past, or predicted future conditions of the roadway being traversed by (or expected to be traversed by) the transport vehicle, as well as the vehicle's current speed over the surface.

The level of precision of pumping that is achievable by the system means that liquid may be pumped on-demand by continually or continuously varying the operating speeds of pump units 118, and thus their flow rates, without need for a relief valve to a vent return-line for directing excess pumped liquid to the tanks 104, because there is substantially no excess pumped liquid during such precise operation. When the liquid demand is decreased according to controller 122, an essentially instant adjustment to flow rate (via motor rpm) can be made based on the known current liquid flow rate compared to the set application rate. The use of self-priming pumps also aids efficiency by eliminating the “spin up” delay of centrifugal pumps, for example. Flow meters 131 associated with pump units 118 are sufficiently precise that pump units 118 may also be used to refill liquid tanks 104 by operating pump units 118 in “reverse mode” and determining when the volume of refilling liquid reaches the volume of liquid that was dispensed since the last refilling operation. It will be appreciated that “reverse mode” may entail changing valve positions to direct liquid flow in the opposition direction to draw liquid out of a supply and direct it into the tanks 104, or may entail running pumps in an opposite direction if such operation (for that type of pump) will result in opposite flow direction. The precision achieved is due in part to the use of positive-displacement pumps 128, such as self-priming dual-diaphragm pumps that are shown in the illustrated embodiments. During spray operations, the pump units 118 may be capable of pumping a brine solution through spray bar 106 at up to about 110 liters per minute.

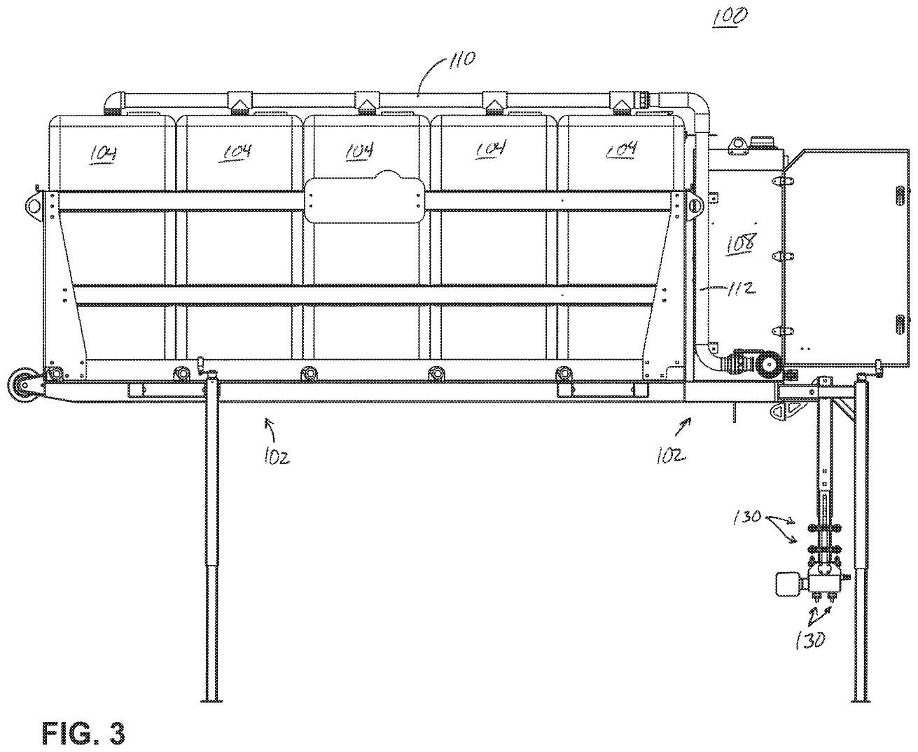

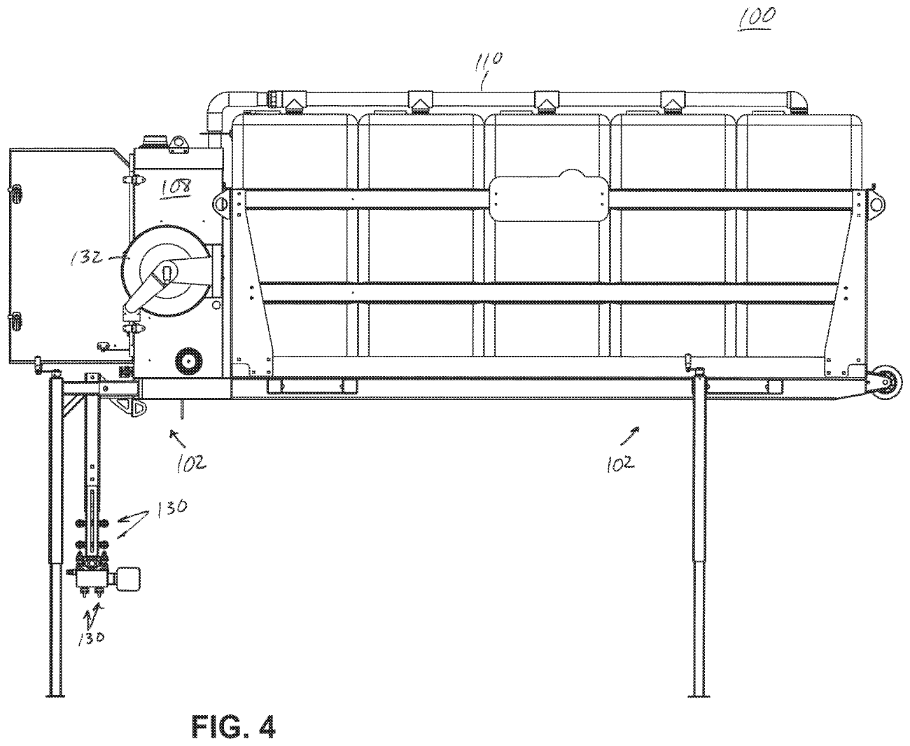

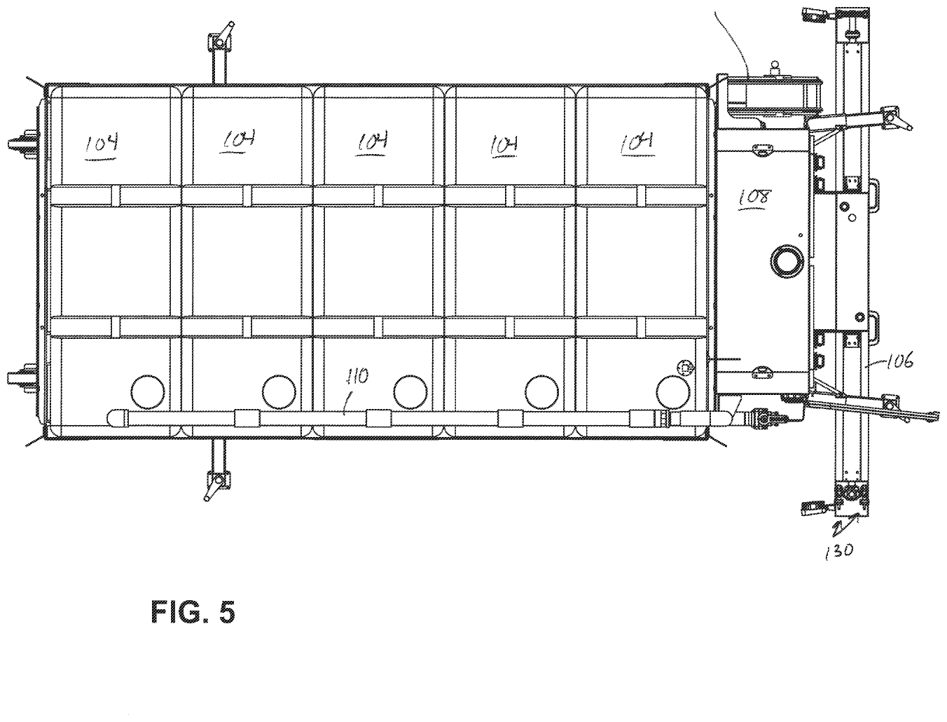

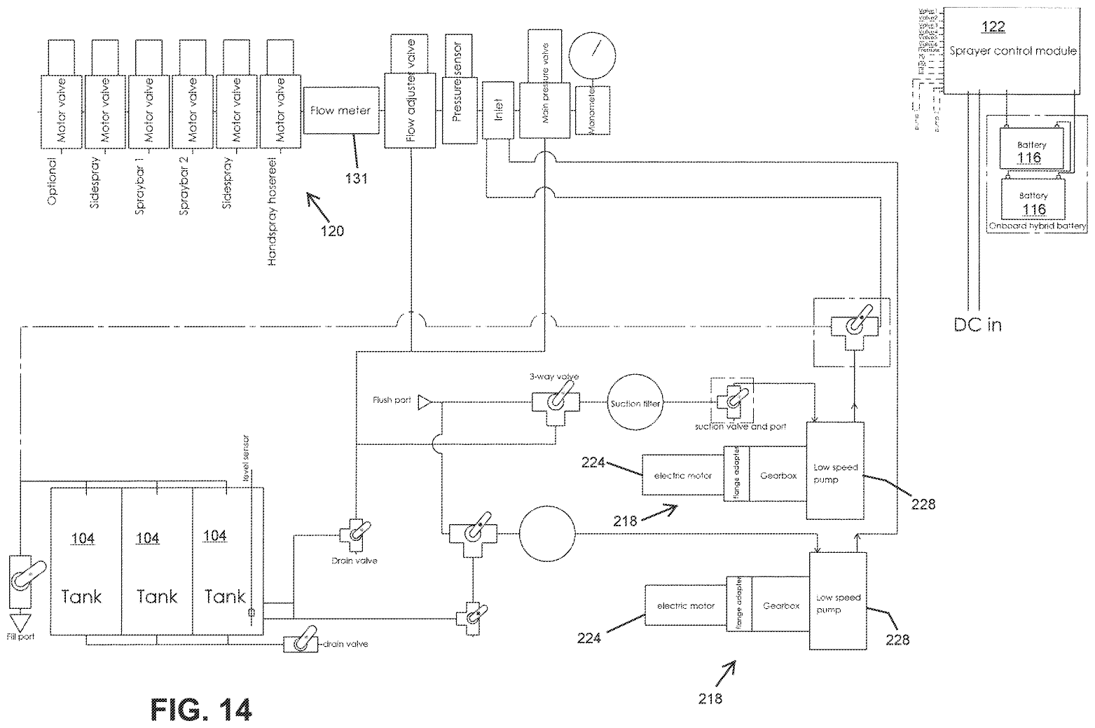

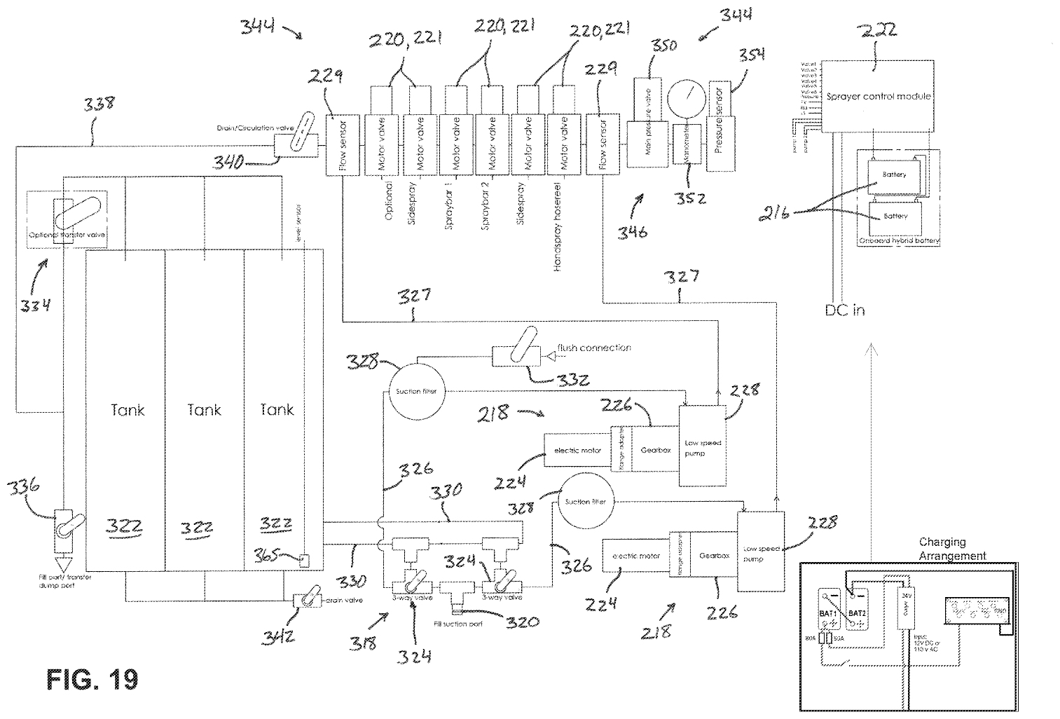

Optionally, a reel-mounted spray hose 132 may be used by an operator to manually aim and apply liquid solutions to sidewalks, building entrances, and the like. Spray bar 106 (FIGS. 1-6) may be configured sufficiently to cover three lanes of roadway in a single pass, with an application rate of 30 ml/m² at a speed of approximately 30 km/h, or about twenty gallons per lane, per mile, at a speed of 20 mph. Spray bars 106 may have widths of 230 cm/90″ and 250 cm/100″ for example, including directional control of each spray bar, for meeting high flow and speed requirements in pre and post treatment applications (low and high speed), without need for changing hoses or other conduits to achieve a desired flow rate. The spray bar 106 may be equipped with individual directional controls on the side spray nozzles to spray two or three lanes widths, and can be equipped with four side nozzles on each side for increased spraying widths up to three lanes. In the illustrated embodiment two spray conduits with their own respective nozzles 130 are contained in spray bar 106 and may be operated independently by the different pump units 118. The flow diagram of FIG. 14 may be readily understood with reference to the above descriptions, as well as the descriptions below with respect to the similar flow diagram of FIG. 19.

The energy efficiency of the system, which does not run pump units 118 at higher speeds (and higher power consumption rates) than is required to achieve the real-time desired flow rate, allows for the use of on-board power supply without relying on the transport vehicle for power. The on-board power supply 116 can be recharged during non-application periods or can be swapped out for a charged power supply 116 so that the depleted power supply can be recharged while removed from the liquid sprayer 100.

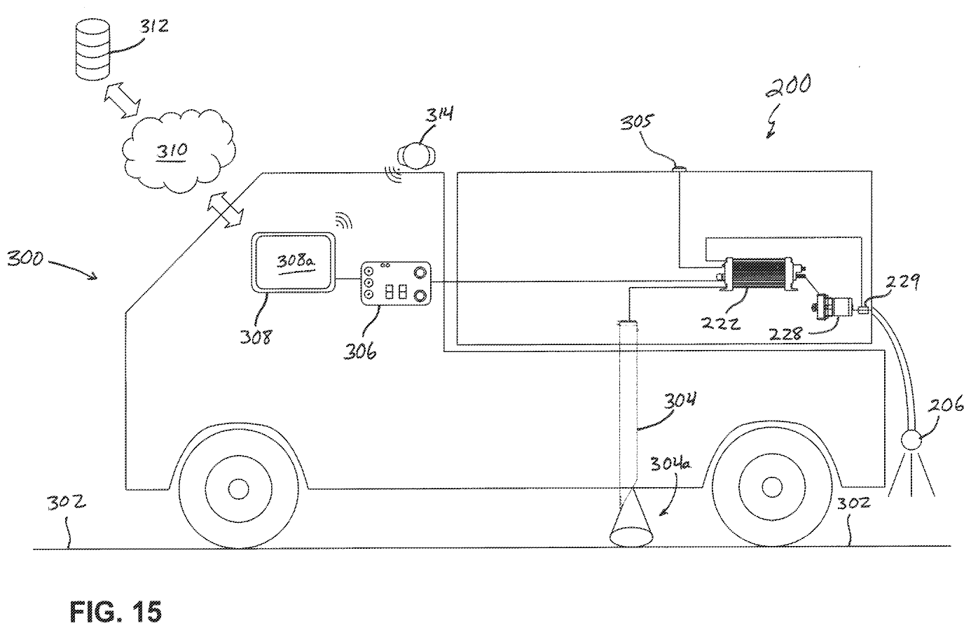

Referring now to FIG. 15, another liquid sprayer system 200 is depicted as being supported on a vehicle 300 that is driven along a roadway surface 302. Liquid sprayer system 200 is equipped with a multi-sensor 304 that has a field of view 304a directed down at roadway surface 302 and is capable of real-time sensing and reporting one or more of: roadway surface temperature, ambient air temperature, ambient air humidity, snow depth on roadway surface 302, water depth on roadway surface 302, ice depth on roadway surface 302, coefficient of friction along roadway surface 302, and existing salinity along the roadway surface 302 such as from prior salt applications. Multi-sensor 304 is available, for example, as the “TempStriker” brand sensor offered by Oy Hilltip Ab of Pietarsaari, Finland. The data collected by multi-sensor 304 may all be sent to a spreader control module 222 that controls pumps, motors (e.g., pump motors, valve actuation motors, etc.), and other devices of the sprayer system 210. The output of multi-sensor 204 may be an analog signal or a digital signal sent via RS-232 connector or other electronic communication protocol. Spreader control module 222 typically includes a closed-loop controller for obtaining accurate liquid flow data from pumps 228 that are equipped with respective flow rate sensors 229, and a GPS receiver 305 for location and speed-of-travel data.

In the illustrated embodiment of FIG. 15, sprayer system 200 further includes a control panel 306 that serves as a communications gateway between spreader control module 222 and an in-vehicle controller 308, which may be a portable or cab-mounted tablet device, for example. Control panel 306 is in communication with the in-vehicle controller 308 via wired (such as USB) or wireless communication protocol. Control panel 306 is in communication with the spreader control module 222 via a wired connection such as a controller area network (“CAN”) protocol, or via a wireless interface. Control panel 306 includes numerous control interfaces such as buttons, switches, rotary encoders, and the like, which allow a driver/operator to control functions of the sprayer system 200. Control panel 306 may include lamps and/or audio speakers to generate signals that are visually and/or audibly perceptible by the driver/operator.

In-vehicle controller 308 includes a human machine interface (“HMI”) such as a touchscreen 308a, and wireless communications capabilities. For example, in-vehicle controller 308 may send and receive data via cellular data and/or WiFi signals 310 in order to receive weather information from a weather data source 312. In-vehicle controller 308 may receive other data from onboard sources, such as a wireless ambient air temperature and humidity sensor 314.

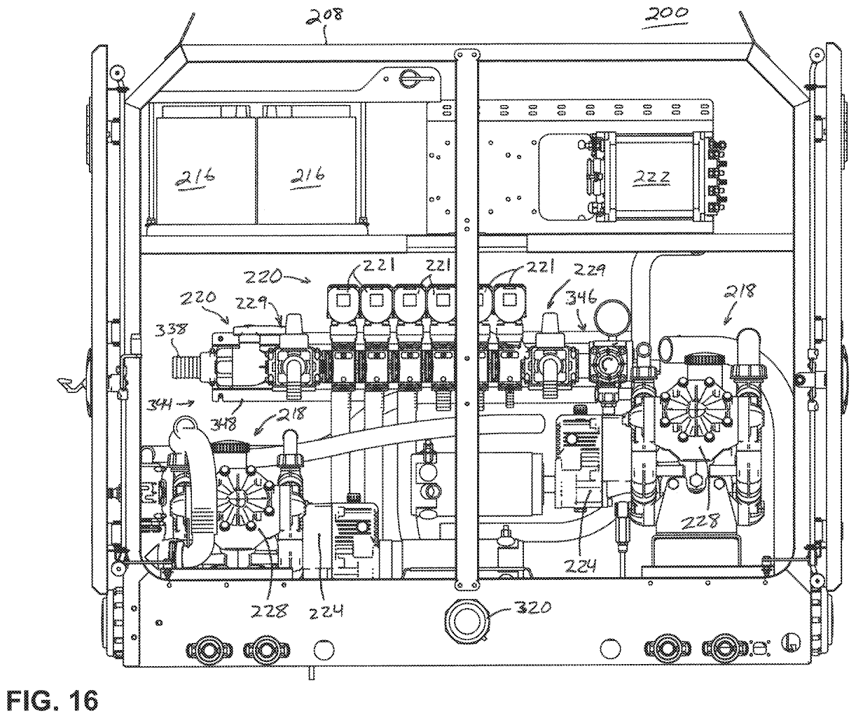

Referring to FIG. 16, the various fluid and electrical components of sprayer system 200 may be seen, and generally correspond to those of sprayer 100 as shown in FIG. 9, with the addition of 100 to their reference numerals so that they can be understood with reference to the above descriptions. These components include a housing 208, two rechargeable 12V DC batteries 216, numerous valves 220 (some manual, some with motorized actuators 221) and associated conduits, a pair of pump units 218 with respective variable-speed electric motors 224 and positive-displacement liquid pumps 228.

A filling valve assembly 318 includes a filling port 320 (FIGS. 16, 17, and 19) that provides a quick-connect fluid coupling for filling or emptying liquid storage tanks 322 of the sprayer system 200, such as shown in FIG. 19. Filling valve assembly 318 includes two manual three-way valves 324 for switching between tank-filling and liquid spraying modes. Each three-way valve 324 has an associated liquid intake conduit 326 that leads liquid from filling port 320 to a respective suction filter 328 (FIG. 19) and then to a respective pump 328, from which the filtered intake liquid passes to one of the flow sensors 229 and then to one or more of the tanks 322 via a tank-filling conduit 338, when valves 324 are in the tank-filling mode. When the three-way valves 324 are in the liquid spraying modes, liquid is drawn from the tanks 322 and through tank conduits 330, then through the three-way valves 324 and to the liquid intake conduit 326, through the suction filters 328, and to the pumps 228. As with the tank-filling operation, the liquid flows through conduits 227 to the flow sensors 229, but unlike the tank-filling operation, in the liquid spraying mode the liquid is directed to various sprayers via valves 220 with motorized actuators 221. In this arrangement, pumps 228 are always turned in the same direction during both tank-filling and liquid-spraying operations, and it is the valve positions that are changed according to the desired operation. In both types of operation, flow sensors 229 are used to accurately measure the flow rate of liquid being directed into tanks 322 or out through the various spray nozzles such as at spray bar 206. It will be appreciated that there may be more than one spray bar 206, sides sprayers, a hose reel sprayer, or the like.

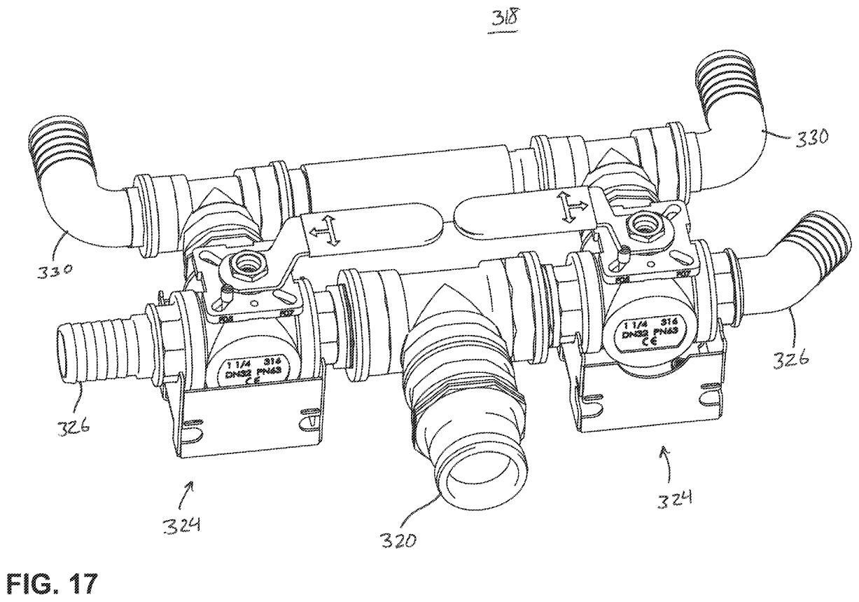

With continued reference to FIG. 19, a flush connection and valve 332 may be used to flush plain water through the fluid system, and optionally air if all liquid is to be removed from the system. An optional transfer valve 334 and associated fill and transfer dump port 336 may be provided to facilitate a rapid pump-out function from the system's tanks 322 to facility storage tanks (not shown), through tank-filling conduit 338 that is normally used to fill the tanks 322 via filling valve assembly 318. To achieve rapid pump-out, transfer valve 334 is closed and the fill and transfer dump port 336 is opened so that operation of pumps 228 with filling valve assembly 318 set to tank-filling mode to draw liquid from tanks 322 through tank conduits 330 and all sprayer valves 220 closed, with a drain/circulation valve 340 open, will cause liquid to be drained from tanks 322 by pumps 228, and out through fill and transfer dump port 336. By comparison, if the same operation were conducted with transfer valve 334 open, the result would be continuous circulation of liquid out of and back into the tanks 322. A gravity drain valve 342 allows for slow (not pump-assisted) draining of the tanks 322, if desired. Optionally, filling valve assembly 318 may be used for faster gravity-dump draining of tanks 322, by positioning the three-way valves 324 so that all four ports (shown at 326 and 330 in FIG. 17) are interconnected with one another. Still further, filling valve assembly 318 may be used for draining of the pumps 228 and suction filters 328 (not draining tanks 322), by positioning the three-way valves 324 so that only the liquid intake conduits 326 are in fluid communication with filling port 320 (which can now serve as a draining port), whereas tank conduits 330 are closed off from filling port 320. Thus, filling port 320 can also be used to gravity-drain the entire fluid system, to drain only the tanks 322, or to drain only the pumps 228, filters 328, and their associated conduits. Optionally, air can be let into the fluid system to hasten the gravity draining, or pressurized air can be directed into the fluid system to further hasten the gravity draining and increase the amount of liquid forced out of the system, reducing the amount of liquid “trapped” by a vacuum or at low points in the system.

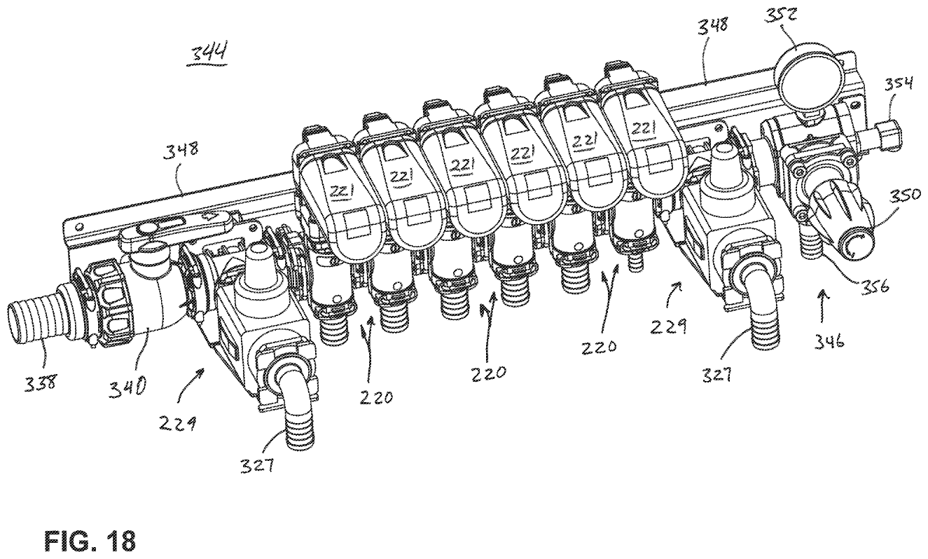

Referring to FIGS. 18 and 19, sprayer valves 220 and their associated motorized actuators 221 are part of a valve assembly 344 that includes the two flow sensors 229, drain/circulation valve 340 with an outlet to tank-filling conduit 338, and a liquid pressure monitoring and adjustment system 346, all supported on a bracket 348 (FIGS. 16 and 18). Liquid pressure monitoring and adjustment system 346 includes a manual pressure regulator 350 that is used to set the maximum fluid pressure in the system, a manometer (pressure gauge with visual display) 352, and an electronic pressure sensor 354 sending data to spreader control module 222 and/or control panel 306 and optionally to in-vehicle controller 308 and display 308a. A vent pipe 356 directs liquid out of the system if the system pressure exceeds the maximum pressure selected at pressure regulator 350.

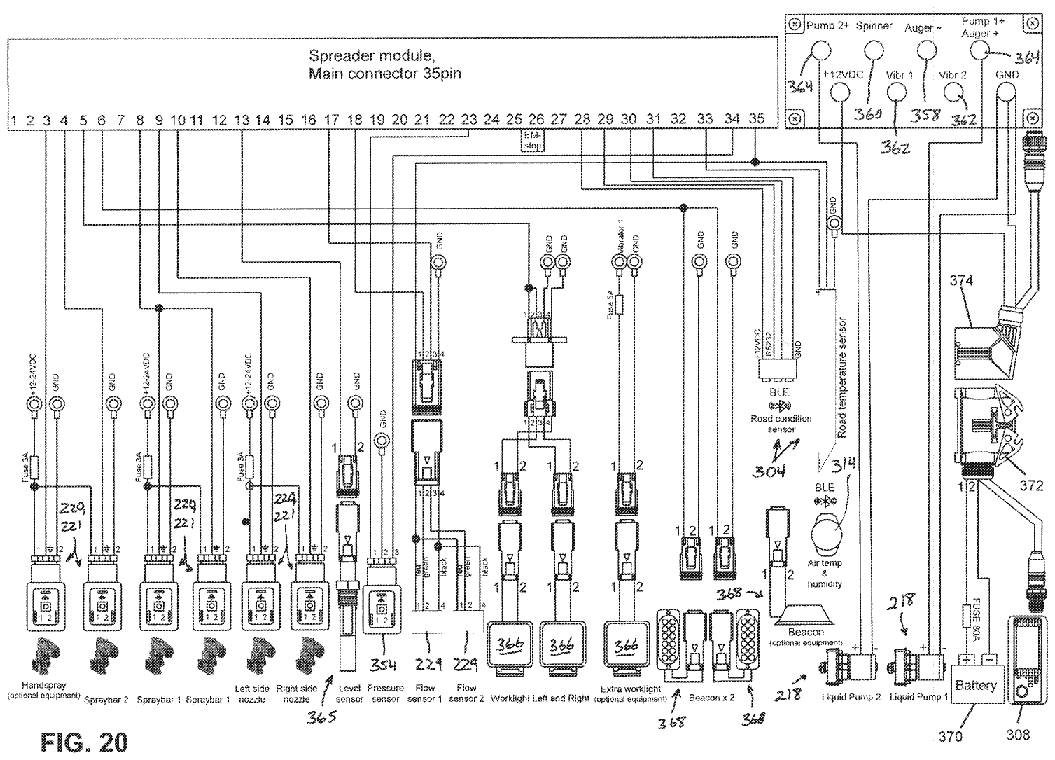

FIG. 20 provides a basic electrical diagram illustrating interconnections between the various components described above, as well as additional equipment whose functions may be integrated into control panel 306. For example, a granular salt auger power output 358, granular salt spinner power output 360, granular salt hopper vibrator power outputs 362, and pump power outputs 364 may all be controlled via control panel 306 and in-vehicle controller 308. A tank liquid level sensor 365 may be installed in one of the tanks 322 and used to supply tank level data, although such data would typically be used as secondary or a backup to more precise tank level data from monitoring flow sensors 229 for the amount of liquid added to and drained from tanks 322, as described in more detail above. Other equipment like work lights 366 for illuminating exterior surroundings of the vehicle 300, and caution beacon flashers 368, may also be mounted on housing 208 and powered and controlled by the driver/operator via control panel 306 and in-vehicle controller 308. However, it will be appreciated that controller 308 and various equipment associated with the vehicle (e.g., exterior lighting and flashers) and/or with other equipment on the vehicle (e.g., a granular salt hopper with auger, vibrator, and spinner/spreader) may have their controllers or even their various motors and other circuits powered by the vehicle's electrical system, represented in FIG. 20 by vehicle battery 370, which supplies power to a pair of connectors 372, 374, the first connector 372 powering the spray system's controller 308.

The liquid sprayer system 200 can automatically adjust the liquid application rate based on the current and forecasted weather and road conditions. It receives current and forecasted weather data 312 from service providers via WiFi or cellular network 310 (FIG. 15). Using onboard road condition sensors 304, system 200 measures current road conditions at the vehicle 300 such as temperature, snow/ice/water thickness, friction, and salinity. Based on this information, system 200 can calculate a recommended application rate for current conditions. Calculations are done continuously while the vehicle 300 is moving, and the recommended application rate is updated continuously when road condition or forecast is changed. The sprayer system 200 can be set to automatically change the application rate, or can be set to make a rate-change recommendation that the driver/operator can review on display 308a and decide whether or not to accept and implement the recommended change. The spreading rate may also be changed according to the detected concentration of salinity already on the roadway surface 302. For example, if the salinity detected on the roadway surface 302 from prior applications is already at 20% of the desired concentration, system 200 can apply a 20% reduction to the recommended application rate so that the recommended salinity concentration is achieved without exceeding it because of salt already present on the roadway surface.

It will be appreciated that accurate calibration of the pumps and sensors is useful to achieve the high levels of flow accuracy desired for liquid spray systems 100, 200. For example, the spray systems may have two different calibrations, one for maximum flow and one for spreading width. The spreading width varies depending on the flow and other factors (e.g. spray bar dimensions and number of nozzles and their type), and therefore the spreading width can be calibrated at a number of different flow rate calibration points so that a desired spreading width can be easily selected and the system selects the appropriate flow rate to achieve it, using a given spray bar 206 and nozzle configurations. When only a small number of nozzles are in use (e.g. one to four nozzles), the flow should be limited so that fluid pressure in the system does not exceed a maximum desired pressure, such as the maximum pressure set at pressure regulator 350. The flow limitation calibration may be achieved by an automatic calibration function that measures the maximum flow in a given spray bar and at a known fluid pressure when different numbers and/or types of nozzles are in use.

Accordingly, the liquid spray systems 100, 200 provide energy-efficient distribution systems that can determine a recommended application rate based on numerous factors ranging from third party weather forecasts to real-time temperature, humidity, roadway contamination, roadway friction, existing salinity, location, and speed, typically for application of brine solutions to roadways. However, it will be appreciated that the liquid spray systems may be adapted for other applications such as distribution of liquid fertilizers, dust-control liquids, and the like. The systems' calculations and controls can be largely automated, with the driver/operator given a desired level of control or override authority, with application rates being continuously updated based on numerous factors that have been found to affect the recommended rates. Quick and accurate filling and draining operations may also be achieved using the same pumps and flow rate sensors that allow precise control of spray application rates. Moreover, the system may be powered solely by onboard electrical storage batteries so that it may be installed on substantially any vehicle that is capable of supporting its weight and bulk, and the system may be scaled up and down in size according to application and the capabilities of the vehicle that is expected to carry it.

Changes and modifications in the specifically-described embodiments may be carried out without departing from the principles of the present invention, which is intended to be limited only by the scope of the appended claims as interpreted according to the principles of patent law including the doctrine of equivalents.

The embodiments of the invention in which an exclusive property or privilege is claimed are defined as follows:

1. A liquid sprayer comprising:
a liquid storage tank;
a liquid pump in fluid communication with said tank;
a variable-speed electric motor operable to drive said pump at different speeds and resultant liquid flow rates;
a controller operable to adjust the speed of said electric motor and the liquid flow rate of said pump in response to at least one control input;
a self-contained electrical power source for powering said electric motor and said controller; and
a plurality of spray nozzles in fluid communication with said pump;
wherein said spray nozzles are configured to dispense a liquid through said outlet openings and onto a ground surface at variable flow rates according to the speed of said electric motor.

2. The liquid sprayer of claim 1, wherein said at least one control input comprises at least one chosen from a user-selected flow rate; a ground speed of the liquid sprayer; a measured ground contamination level and type; a measured ground temperature; ambient air temperature; ambient air humidity; a remotely-selected flow rate based on past, current, or forecasted weather conditions; a planned route of the liquid sprayer; and a size or configuration of said spray nozzles.

3. The liquid sprayer of claim 1, wherein said spray nozzles are mounted upon a spray bar forming a conduit between said liquid pump and said spray nozzles.

4. The liquid sprayer of claim 3, wherein said spray nozzles are aimable and/or have adjustable spray patterns, and wherein said spray nozzles are remotely controllable for aim and/or spray pattern.

5. The liquid sprayer of claim 1, wherein said self-contained electrical power source comprises a rechargeable electrical storage battery.

6. The liquid sprayer of claim 1, wherein said liquid sprayer is mountable on a transport vehicle for dispensing the liquid onto a roadway.

7. The liquid sprayer of claim 6, wherein said electrical power source does not receive electrical charging current from a wiring harness of the transport vehicle.

8. The liquid sprayer of claim 1, wherein the speed of said variable-speed electric motor is continuously variable between a minimum speed and a maximum speed, and wherein the resultant liquid flow rates are variable in direct proportion the speed of said variable-speed electric motor.

9. The liquid sprayer of claim 8, wherein said controller and said electric motor are operable to change the liquid flow rate of said pump at intervals of 0.1 second or less based on said at least one control input.

10. The liquid sprayer of claim 1, wherein said liquid pump is operable to pump the liquid into the liquid storage tank from a remote liquid source.

11. The liquid sprayer of claim 1, wherein said controller is configured to automatically adjust the speed of said electric motor in response to a current flow rate, a current fluid pressure upstream of said spray nozzles, a desired liquid application rate, and a speed of said spray nozzles over a ground surface.

12. The liquid sprayer of claim 1, wherein said liquid pump comprises a positive-displacement pump.

13. The liquid sprayer of claim 12, wherein said liquid pump comprises a self-priming diaphragm pump.

14. A method of dispensing liquid onto a ground surface, said method comprising:
securing a self-contained liquid spraying system to a transport vehicle, the spraying system comprising a plurality of components including an electrical storage device, a controller, a variable-speed electric motor coupled to a liquid pump, a liquid storage tank, a speed sensor, and a spray nozzle, wherein each of said plurality of components is coupled to a spraying system housing;
driving the transport vehicle along a road surface;
detecting the speed of the transport vehicle speed with the speed sensor and sending the detected speed to the controller that is energized by the electrical storage device;
determining a desired liquid flow rate according to the vehicle speed;
electrically energizing the variable-speed electric motor with electrical power from the electrical storage device to drive the liquid pump at the desired liquid flow rate;
drawing the liquid out of the liquid storage tank with the liquid pump and directing the liquid out of the spray nozzle at the desired liquid flow rate; and
automatically changing the desired liquid flow rate with the controller upon detecting a change in the speed of the transport vehicle.

15. The method of claim 14, further comprising adjusting the desired liquid flow rate based on at least three chosen from: a user-selected flow rate; a measured ground contamination; a measured ground temperature; a measured ground salinity; ambient air temperature; ambient air humidity; a remotely-selected flow rate based on past, current, or forecasted future weather conditions; a planned route of the liquid sprayer; and a size or configuration of said spray nozzles.

16. The method of claim 14, further comprising:
planning a route through a geographical region before or during said driving the transport vehicle along the road surface;
entering the route into the controller;
receiving weather data for the geographical region into the controller; and
adjusting the desired liquid flow rate based upon the received weather data.

17. The method of claim 16, further comprising:
detecting contamination on the road surface beneath the transport vehicle during said driving the transport vehicle along the road surface, and directing contamination data to the controller;
detecting temperature of the road surface beneath the transport vehicle during said driving the transport vehicle along the road surface, and directing the road surface temperature to the controller;
detecting salinity at the road surface beneath the transport vehicle during said driving the transport vehicle along the road surface; and
further adjusting the desired liquid flow rate based upon the contamination data, the road surface temperature, and the salinity.

18. The method of claim 14, wherein said electrical power storage device comprises a rechargeable electrical storage battery.

19. The method of claim 14, wherein said automatically changing the desired liquid flow rate comprises changing the liquid flow rate of said liquid pump at intervals of 0.1 second or less.

20. The method of claim 19, wherein the liquid pump comprises a self-priming positive-displacement pump
